(19) United States
(12) Patent Application Publication
(10) Pub. No.: US 2004/0146188 A1
(43) Pub. Date: Jul. 29, 2004

(54) Contoured prism print scanners

(76) Inventors: John F. Carver, Palm City, FL (US); George W. McClurg, Jensen Beach, FL (US)

Correspondence Address: STERNE, KESSLER, GOLDSTEIN & FOX PLLC, 1100 NEW YORK AVENUE, N.W., WASHINGTON, DC, 20005, US

(21) Appl. No.: 10/635,009

(22) Filed: Aug. 6, 2003

Related U.S. Application Data
(60) Provisional application No. 60/401,010, filed on Aug. 6, 2002.
(60) Provisional application No. 60/401,007, filed on Aug. 6, 2002.

(51) Int. Cl. G06K 9/00

(52) U.S. Cl. 382/127

(57) ABSTRACT

The present invention provides contoured prisms for live print scanners. In one embodiment, a print scanner has a rotatable prism and an imaging assembly. The rotatable prism has a curved platen surface for receiving a print pattern. The rotatable prism rotates relative to the imaging assembly during a live scan. The imaging assembly captures line scan images of the print pattern as the rotatable prism rotates. In one embodiment, the rotatable prism is a cylindrical prism and the curved platen surface is cylindrical. In a further embodiment, a print scanner includes an arched prism and an imaging assembly. The arched prism has a curved platen surface for receiving a print pattern.

### CROSS-REFERENCE TO RELATED APPLICATIONS

This application claims the benefit of U.S. Provisional Patent Application No. 60/401,010, to Carver et al., filed Aug. 6, 2002, and the benefit of U.S. Provisional Patent Application No. 60/401,007, to Carver et al., filed Aug. 6, 2002, both of which are incorporated by reference herein in their entirety.

### BACKGROUND OF THE INVENTION

1. Field of the Invention

The present invention pertains to biometric imaging technology, and in particular, to live scanning of prints.

2. Background Art

Print imaging systems can capture images of prints on thumbs, fingers, palms, toes, feet, and/or hands. Such print imaging systems are also referred to as live scanners, live print scanners, or simply scanners. Live scanners often include a light source, platen and camera. An object having a print pattern is placed on the platen. A platen is often one planar surface of a prism. The light source illuminates the platen. The camera captures an image of a print placed on the platen.

Live print scanners utilize the optical principle of frustrated total internal reflection (TIR) to capture a high-quality image of a print pattern. Such a print pattern includes ridges and valleys that make up all or part of a print. For example, ridges on a finger can operate to alter the refraction index at a platen surface compared to valleys, thereby interrupting the TIR of light at the platen surface. This interruption in the TIR causes a high quality optical image representative of the ridges and valleys of a print pattern to be captured by a camera.

One problem with conventional palm live scanner systems is that a palm naturally curves, while a typical platen has a flat planar surface upon which a palm is placed. Thus, there is a chance that not all portions of the palm print, especially the pocket in a center of a palm, will be imaged during scanning. If this occurs, a “dead spot” can occur at the palm pocket and biometric information can be lost.

Attempts have been made to provide a convex or non-planar platen that better fits the shape of a palm. See, U.S. Pat. Nos. 5,528,355, 6,038,332 and 6,175,40. What is needed are improved print scanners with contoured prisms.

### BRIEF SUMMARY OF THE INVENTION

The present invention provides contoured prisms for live print scanners. In an embodiment, a print scanner has a rotatable prism and an imaging assembly. The rotatable prism has a curved platen surface for receiving a print pattern. The rotatable prism rotates relative to the imaging assembly during a live scan. The imaging assembly captures line scan images of the print pattern as the rotatable prism rotates.

In one embodiment, the rotatable prism is a cylindrical prism with a cylindrical platen surface. The cylindrical prism has a hole region in a center region to accommodate a shaft, and first and second tapered side face regions that extend from the cylindrical platen surface to the hole region. According to a feature, the imaging assembly includes an illumination source positioned at least partly within the first tapered side face region, and an optical system positioned at least partly within the second tapered side face region. In this way, a live scanner can be compact and relatively small in size while having a large scanning area. The use of a linear sensor also reduces cost.

In an embodiment, the live scanner further includes a motion control system that provides a force to reduce or eliminate excessive rotational speed of the cylindrical prism during a live scan. The motion control system includes a shaft encoder and a drive motor.

According to a further embodiment, a print scanner includes an arched prism and an imaging assembly. The arched prism has a curved platen surface for receiving a print pattern. The imaging assembly rotates along a scan arc relative to the arched prism during a live scan. The imaging assembly captures line scan images of the print pattern as the imaging assembly rotates along the scan arc. An object with a print pattern such as a palm and/or hand is placed lengthwise on the curved platen along the scan arc direction. According to a feature, the curvature of the arched prism generally extends along the length of the arched prism in a scan arc direction. Little or no curvature may be provided in the width direction to avoid foreshortening of rays or other distortions, and to maintain total internal reflection with the prism.

In an embodiment, the arched prism has two end faces and three arched side regions. The three arched side regions each have an arch shape that curves along the direction of the scan arc. One of the three arched side regions includes the curved platen surface. A second arched side region faces an illumination source. The illumination source is positioned to inject light at the first arched side region to provide light and illuminate the print pattern on at least a portion of the cylindrical platen surface on the second arched side region. A third arched side region faces an optical system and linear sensor. The optical system is positioned to direct light traveling from the third arched side region to the linear sensor for capture in successive line scans as the imaging assembly is rotated relative to the arched prism during a live scan.

Another advantage of contoured prisms in the present invention, including rotatable prism and arched prism embodiments, is the substantial elimination of the “dead spot”. By placing the hand with its palm pocket atop of the curved platen surface, the dead spot can be reduced or eliminated compared to a flat platen surface.

Further embodiments, features, and advantages of the present invention, as well as the structure and operation of the various embodiments of the present invention are described in detail below with reference to the accompanying drawings.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the pertinent art to make and use the invention.

FIG. 1 is a diagram of a print scanner having a rotatable cylindrical prism according to an embodiment of the present invention.

FIG. 2 is a diagram of the rotatable cylindrical prism of FIG. 1 in more detail.

FIG. 3 is a diagram of a print scanner having an arched prism according to an embodiment of the present invention.

The features, objects, and advantages of the present invention will become more apparent from the detailed description set forth below when taken in conjunction with the drawings in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

The present invention relates to a print scanners having contoured prisms with curved platen surfaces. While the present invention is described herein with reference to illustrative embodiments for particular applications, it should be understood that the invention is not limited thereto. Those skilled in the arts with the access to the teachings provided herein will recognize additional modifications, applications, and embodiments within the scope thereof and additional fields in which the present invention will be of significant utility.

FIG. 1 is a diagram that illustrates a live print scanner 100 according to an embodiment of the present invention. Print scanner 100 includes a rotating prism 102 having a curved platen surface. The curved platen surface can be a surface of the prism itself on the outer circumference of rotating prism 102. Alternatively, a protective material, such as a silicon pad or other thin transparent material in optical contact with prism 102, can be placed on the outer prism surface and used as a platen surface for rotating prism 102. Rotating prism 102 further includes a hole region that can accommodate a shaft 104.

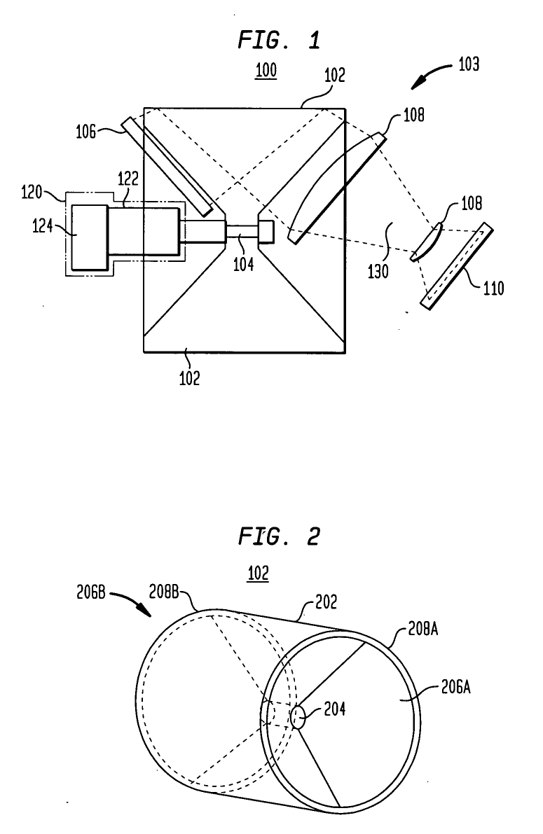

According a feature of the present invention, rotatable prism 102 can be a solid cylindrical prism 202 with a cylindrical platen surface as shown in FIG. 2. The cylindrical prism 202 has a hole 204 in an axially-located center region to accommodate shaft 104. Cylindrical prism 202 further includes opposing first and second tapered side face regions 206A, 206B. Regions 206A, 206B extend from respective edges 208A, 208B of the cylindrical platen surface of prism 202 to hole 204. The present invention is not intended to be necessarily limited to a cylindrical shape, and other shapes can be used as would be apparent to a person skilled in the art given this description. Rotatable prism 102 can be made of glass, plastic, or other suitable transparent material.

Scanner 100 further includes an assembly 103 having illumination source 106, optics 108 and linear sensor 110 placed along an optical path 130. Light emitted by illumination source 106 travels along optical path 130 through rotating prism 102 to illuminate a region of the platen surface of rotating prism 102. A user places an object with a print pattern such as a hand or palm on the platen surface of rotating prism102. Light is then totally internally reflected within rotating prism 102 such that an image of the print pattern on the platen surface is focused by optics 108 onto linear sensor 110. Optics 108 can be an optical system made up of a single lens, a combination of lenses, and/or other optical elements to direct an image of the a print pattern to sensor 110. In one example, a telecentric optical system is preferred. Sensor 110 then captures an image of the print pattern placed on the platen surface of prism 102 and forwards it for storage in memory and for subsequent image processing. Examples of subsequent processing include but are not limited to, filtering and other image processing techniques to remove image artifacts and other undesirable aspect of the captured image, extraction to extract minutia data, matching, and/or other print image processing operations.

In one embodiment, a linear sensor 110 is used that captures a linear image of a platen. A user places an object having a print pattern (such as, a hand or palm) on rotating prism 102. The user then moves the hand, which is in frictional contact with the rotating prism 102, to cause rotating prism 102 to rotate around shaft 104. As the hand rotates different portions of a print pattern on the hand are brought within optical path 130 and captured in a series of line scanned images by linear sensor 110. These captured line scan images are then grouped and processed to obtain a raw image of an entire scanned area of interest.

One advantage of the present invention is that the curved platen surface of rotating prism 102 allows a print image of a palm to be captured with little or no dead space in the palm pocket.

In a further feature, a compact geometry is realized for scanner 100. At least a portion or all of illumination source 106 and optics 108 are positioned near first and second tapered sides of prism 102, respectively, as shown in FIG. 1.

According to a further feature, scanner 100 includes a motion control system 120 to prevent scans at an excessive speed. Motion control system 120 acts to provide a force that opposes the movement of prism 102 and prevents a user from rotating prism 102 too quickly. An excessive scan speed arises when a rapid movement by a user raises a potential for degradation of the captured quality of a print image or other undesirable effects.

Motion control system 120 includes a drive motor 122 and encoder 124 and a processor or control logic (not shown). Motor 122 is coupled to shaft 104 and under the control of motional control system 120 provides a force in a direction opposite to the rotational movement of prism 102 to prevent an excessive rotational speed during a line scan. Encoder 124 measures the position of the rotating prism 102. For example, encoder 124 can be a shaft encoder that determines the rotational position of prism 102 about shaft 104. Encoder 124 can use an incremental or absolute position encoding scheme. Encoder 124 can include, but is not limited to, an optical shaft encoder, magnetic shaft encoder, or other type of shaft encoder.

In one example, motion control system 120 can be a motion control system for controlling platen movement as described in application No. 09/425,888 filed on Oct. 25, 1999 by Gary Barton, et al., now pending (incorporated by reference in its entirely herein). In this example, motion control system 120 senses the velocity of rotating prism 102 imparted by a user during a live scan based on the output of encoder 124 and then produces an appropriate drive signal to drive motor 122 such that a force is applied to counter the rotating prism 102. The magnitude of the counter force is a function of the velocity at which the rotating prism 102 is being moved. In this way, motor 122 acts to provide an appropriate resistance to attempts by users to scan and move rotating prism 102 too quickly. This enables a high quality image of a print pattern to be captured even when inexperienced users are using scanner 100.

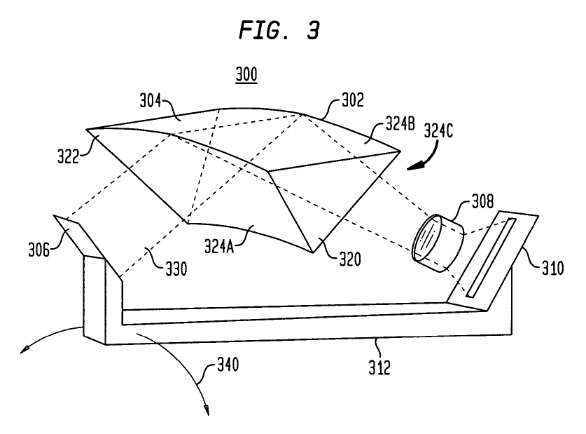

FIG. 3 is a diagram illustrating a live scanner 300 according to a further embodiment of the present invention. Live scanner 300 includes an arched prism 302, illumination source 306, optics 308, and linear camera 310. According to a feature of the present invention, arched prism 302 has an arched shape including an arched platen surface 304. The arched platen surface 304 allows a more accurate fit to be made with biometric objects such as a palm or foot. As shown in FIG. 3, in an embodiment, arch prism 302 is a five sided prism having two end faces 320, 322, and three side faces 324A-C therebetween. Side face 324B can include arched platen surface 304. Arched prism 302 can be made of glass, plastic, or other suitable transparent material.

In an embodiment, arched prism 302 is stationary during a live scan relative to scanner member 312. Scanner member 312 supports illumination source 306 and optics 308 and linear camera 310. During a live scan, scanning member 312 moves along an arcuate path 340 to scan a print pattern on platen surface 304. In particular, illumination source 306 provides light through side face 324A and illuminates platen surface 304 along optical path 330. Light reflected from platen surface 304 passes through side face 324C and is imaged by optics 308 and focused onto linear camera 310. Linear camera 310 then captures a series of line scanned images during a live scan. The series of line scanned images are stored for further processing as is well known in print scanning. For example, the series of line scanned images can be processed to remove artifacts or other desirable features of raw image data. Other image processing operations can include extraction to obtain print minutiae or other print processing operations.

Scanning member 312 (also called a chassis) rotates in an arc 340 that is similar to the radius of curvature of arched prism 302 as shown in FIG. 3. This rotation allows an accurate scan of all or part of the curved prism surface 324B ensuring capture of a relatively large area of platen surface 304. In particular, forensic quality print images of 500 dots per inch (dpi) or greater can be captured.

Example embodiments of the methods, systems, and components of the present invention have been described herein. As noted elsewhere, these example embodiments have been described for illustrative purposes only, and are not limiting. Other embodiments are possible and are covered by the invention. Such embodiments will be apparent will be apparent to persons skilled in the relevant art(s) based on the teachings contained herein. Thus, the breadth and scope of the present invention should not be limited by any of the above-described exemplary embodiments, but should be defined only in accordance with the following claims and their equivalents.

What is claimed is:

1. A print scanner, comprising:
a rotatable prism having a curved platen surface for receiving a print pattern;
an imaging assembly for capturing line scan images of the print pattern as said rotatable prism rotates relative to said imaging assembly during a live scan.

2. The print scanner of claim 1, wherein said rotatable prism comprises a cylindrical prism, and said curved platen surface is cylindrical.

3. The print scanner of claim 2, wherein said cylindrical prism has a hole region in a center region to accommodate a shaft, and further includes first and second tapered side face regions that extend from the cylindrical platen surface to said hole.

4. The print scanner of claim 3, wherein said imaging assembly includes:
an illumination source positioned at least partly within said first tapered side face region to provide light to illuminate the print pattern on at least a portion of said cylindrical platen surface.

5. The print scanner of claim 4, wherein said imaging assembly further includes:
an optical system positioned at least partly within said second tapered side face region to provide images of said print pattern on said cylindrical platen surface along an optical path to a linear sensor for capture in successive line scans as said cylindrical prism is rotated by a user during a live scan.

6. The print scanner of claim 5, further comprising a motion control system that provides a force to reduce the rotational speed of said cylindrical prism during a live scan.

7. The print scanner of claim 6, wherein said motion control system includes a shaft encoder and a drive motor.

8. A print scanner, comprising:
an arched prism having a curved platen surface for receiving a print pattern;
an imaging assembly for capturing line scan images of the print pattern, said imaging assembly being rotatable along a scan arc relative to said arched prism during a live scan.

9. The print scanner of claim 8, wherein said arched prism comprises two end faces and three arched side regions, said three arched side regions having an arch shape that curves along the direction of the scan arc, and one of said three arched side regions includes said curved platen surface.

10. The print scanner of claim 8, wherein said arched prism includes first, second and third arched side regions, each having an arch shape that curves along the direction of the scan arc, and said second arched side region includes said curved platen surface, and wherein said imaging assembly includes:
an illumination source positioned to inject light at said first arched side region to provide light to illuminate the print pattern on at least a portion of said cylindrical platen surface on said second arched side region.

11. The print scanner of claim 10, wherein said imaging assembly further includes an optical system and linear sensor, said optical system being positioned to direct light from said third arched side region to said linear sensor for capture in successive line scans as said imaging assembly is rotated relative to said arched prism during a live scan.
